(19) United States
(12) Patent Application Publication
(10) Pub. No.: US 2007/0106630 A1
(43) Pub. Date: May 10, 2007

(54) Method of enabling an application to access files stored on a removable storage medium

(75) Inventors: Richard Colin Fitzgerald, Surrey (GB); Graham Phillip Oldfield, London (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: Symbian Software Limited, London (GB)

(21) Appl. No.: 10/561,490

(22) PCT Filed: Jun. 23, 2004
(86) PCT No.: PCT/GB04/02711

§ 371 Date: Dec. 20, 2005

(30) Foreign Application Priority Data
Jun. 23, 2003 (GB) 0314593.5

(51) Int. Cl. G06F 17/30

(52) U.S. Cl. 707/1

(57) ABSTRACT

Symbian OS applications assume a directory structure that has been defined by Symbian and defines a standard set of directories starting from the root of a drive. This is not compatible with the Memory Stick standard. The method presented provides applications with a drive that appears to be a standard Symbian drive but actually transparently maps to a safe area on the Memory Stick. It is also possible to access special Memory Stick defined root directories (e.g. for pictures and audio) and to map these directories to standard Symbian-style directories.

### BACKGROUND OF THE INVENTION

1. Field of the Invention

This invention relates to a method of enabling an application, running on an operating system, to access files stored on a removable storage medium; the operating system and the storage medium use incompatible directory hierarchies.

2. Description of the Prior Art

SymbianOS™ applications assume a directory structure that has been defined by Symbian Limited to include a standard set of directories starting from the root of a drive. Unfortunately, this is not compatible with the Memory Stick™ standard defined by Sony Corporation for its removable memory drives. More specifically, SymbianOS defines a directory structure on removable drives which contains a number of standard locations, the most basic being:

\
\System
\System\Apps
\System\Libs
\System\Data
\Documents

Only some of these may exist. Some may contain further subdirectories—for example installed applications are placed in a directory below \System\Apps named after the application, and there are various other standard directories.

By contrast, Memory Stick defines a hierarchy like this:

\DCIM
\HiFi
\MSXXX\...
\MSYYY\...

Importantly, the Memory Stick standard says that only the defined root subdirectories may be placed in the root. All device-specific data that is not part of the standard must be placed inside one of the MSXXX\MSYYY subdirectories, where the “XXX” “YYY” is a sequence of characters registered with Sony and unique to that device or manufacturer.

Clearly this is not compatible because SymbianOS defines a directory hierarchy starting at the root but the Memory Stick standard does not allow non-standard directories in the root. To comply with the Memory Stick standard, the SymbianOS hierarchy would have to be inside an MSXXX subdirectory. But all SymbianOS code (including most, if not all, third-party code) has been written assuming the root-based directory structure and cannot easily be modified to use one compliant with Memory Stick.

Changing every SymbianOS application to comply with the Memory Stick hierarchy is a large effort that it would be preferable to avoid. Even if this were done, it would be difficult to verify that there are no “rogue” cases which could create an illegal root directory.

European Patent Application No. EP1122647A2 filed by Hewlett-Packard Company entitled “A method and apparatus for virtualizing file access operations and other I/O operations” describes a method of enabling a media hierarchy as seen by applications to be mapped to a different file system. It does not however relate to making incompatible media directory hierarchies, which cannot otherwise be modified, interoperate. This interoperability is the basis of the present invention. '647 is also structured in a different manner from the present invention, being a configurable layer on top of the existing file system. This means that the original unmodified file system is still present and so any application or code which is able to access the original file system can bypass the remapping. Also, since the remapping is intended to be configured there is possibility of it being incorrectly configured, or reconfigured. This prior art deals specifically with the remapping by string substitution—this is not the most efficient method but is a consequence of the design as a layer on top of the original file system.

It also requires that a method exists to interpose the described string substitution module between the original file system and clients of that file system. Further, it is concerned with the aim of virtualising file system resources, whereas the present invention is concerned with providing interoperability between two implementations of the same file system with differing directory hierarchy rules. It also does not consider the possibility that a mapping created by string substitution as described may lead to a circular or ambiguous reference to the file—for example, should the same file be opened using two different request paths, file-sharing control code in upper layers will not recognize these paths as the same file and will not therefore provide proper sharing and arbitration control on accesses to the file. Finally, it does not consider conditionally accepting or rejecting or hiding certain path mappings depending on the type of request (see the description of directory listing handling in the present invention for an example of how and why the present invention considers this).

### SUMMARY OF THE PRESENT INVENTION

In a first aspect of the invention, a method of enabling an application, running on an operating system with a first directory hierarchy, to access files stored on a removable storage medium using a second directory hierarchy that is incompatible with the first directory hierarchy, comprises the following steps:
(a) the application sends a file request with a path that conforms to the first directory hierarchy; and
(b) the file system starts a search for the file from a location within the second directory hierarchy that is different from the start location defined by the file request.

In an implementation, a prefix (referred to as a “magic” prefix in this specification) may be attached to the original file request; the filesystem will interpret this magic prefix so as to change where the search begins on the second directory hierarchy. The content and form of the prefix may bear no relation to the actual search location on either the first or second hierarchy

The filesystem may also filter out or ignore parts of the second directory hierarchy during the search so as to present a view of the second directory hierarchy that conforms to the layout of the first directory hierarchy, or to hide parts of the second hierarchy to which access should be denied.

The effect is to map or translate all paths in application file requests to the equivalent path needed by the storage medium, but without the need for string substitution. Hence, a path that conforms to the SymbianOS standard can be transparently mapped to a Memory Stick path: it is ‘transparent’ in that the application has no awareness of the path lookup algorithm used: it simply sees the standard hierarchy mandated by the OS. The translation is also transparent to the file server component of the operating system. Prior art systems do not address the problem of enabling an application running on an OS with a specific directory hierarchy to access files held on a removable drive that uses a different and incompatible directory hierarchy. Instead, whilst they may deal with translating file requests from a virtual address to a physical one, both addresses must always conform to the same directory hierarchy.

A second aspect of the invention is a portable computing device programmed to enable an application running on it to access files stored on a removable storage medium, in which the application sends a file request with a path that conforms to a directory hierarchy used by the device operating system, the device being further programmed to search for the path in the file request starting from a location within a second directory hierarchy used by the storage medium, the second directory hierarchy being incompatible with the first.

### DETAILED DESCRIPTION

The present invention will be described with reference to an implementation for Symbian OS, the operating system for smartphones and other wireless information devices. This implementation enables applications written to run on SymbianOS and using the file hierarchy mandated by SymbianOS to use the Memory Stick storage medium, even though Memory Stick uses an entirely different directory hierarchy.

Root Remapping

The requirement is that applications should see a drive (say drive D:) which appears to be a standard Symbian hierarchy but which actually is located somewhere off the root on the Memory Stick. In addition, applications should not directly see the real root of the Memory Stick but that the root should still be available to applications by some method.

Notionally, all paths that refer to drive D: are automatically prefixed by an extra path, called the root offset. This root offset is equal to the location on the Memory Stick at which the data on the D: drive actually exists. This happens completely transparently and applications are not aware of the change.

Note that in practice the translation does not concatenate two strings to form a third string, since this is not the most efficient method of translation. However this describes the effective behaviour.

In practice, the file system is programmed such that it is aware of where within the target directory hierarchy the client requests are located (see the final section titled Mapping without string concatenation or manipulation. When handling a client request, the file system will locate the actual target file or directory by starting the search for the requested path from a predefined location within the target directory hierarchy.

When a file system receives a request for a certain path, it will locate the requested file or directory by looking up each element of the path until the entire path has been scanned.

For example the path

\Foo\Bar\file.txt

has three elements. The first step is to locate the directory Foo. Secondly, to locate Bar within Foo. Thirdly, to locate file.txt within Bar. At that point the entire path has been processed and file.txt is the result. Conventionally, the search for a path will always start from the root of a drive. However, in the present invention the search for the fir element of the requested path will begin from some other location within the target directory hierarchy.

For example, consider that the root directory registered with Sony is MSSymbian. We want the Symbian hierarchy on drive D: to actually be placed inside the MSSymbian directory. Notionally, the string “\MSSymbian” is added to the start of all paths accessing drive D:.

So for example, take a Memory Stick that has this directory structure:

\
\DCIM
\HiFi
\MSSymbian
\MSSymbian\System
\MSSymbian\Documents

If an application requests a directory listing of “D:\*”, the file system will notionally convert this to “D:\MSSymbian\*” and give the result:

\System
\Documents

which is the standard Symbian layout as expected by the application. Note that to the application this appears to be the root of the drive but actually it is not.

In practice, the file system begins its process of looking up the requested path “\” starting from the predefined directory “\MSSymbian” rather than the root.

If the application were now to create a directory “\Documents\MyFiles”, this would be notionally translated again by the file system to “\MSSymbian\Documents\MyFiles”.

This therefore allows applications to continue using the Symbian hierarchy but enforces compliance with the Memory Stick standard.

Accessing the Root—the Magic Directory

The root offset method described above hides the root completely. Some applications may be Memory Stick aware (that is, they understand the Memory Stick structure and will want to access some of the standard interchange directories defined in the standard). To allow access to the root, a “magic” directory is provided, \System\MSROOT. This is really the reverse of the root offset because it is notionally stripped from all paths passed to the file system.

In practice again the implementation is for the magic directory to alter which predefined location the search for the requested path will begin. In this case, when the magic directory is seen the file system will use the root of the target directory hierarchy as the start point for the path lookup, and skip the magic directory element of the requested path.

So for example if an application wants to access the Memory Stick \DCIM directory (for images), it would use the path “\System\MSROOT\DCIM”. The file system would then notionally strip (i.e. skip) the magic prefix “\System\MSROOT” from this to leave “\DCIM”, the intended target directory.

The reason for providing access to the root in this manner rather than allowing applications to view the real Memory Stick hierarchy is to enforce compliance with the hierarchy. If the full Memory Stick root were visible—on another drive letter for example, applications could accidentally violate the Memory Stick specification by creating files and directories on this drive.

Overlaying an Existing File or Directory

The magic directory does not actually exist on the Memory Stick, so if the Memory Stick held a real file or directory \MSSymbian\System\MSROOT, the magic directory would hide it.

The presence of a real file/directory called \System\MSROOT does not interfere with the operation of the “magic” directory because it is handled entirely within the file system. There is never any lookup of the path “\System\MSROOT” in the target directory hierarchy.

However, the user may want to access this file/directory—this is still possible in two ways:
a) Use the “partial circular reference”:
   \System\MSROOT\MSSymbian\System\MSROOT
   which will be map to:
   \MSSymbian\System\MSROOT
   on the Memory Stick, since the presence of the magic directory will cause the lookup of path “\MSSymbian\System\MSROOT” to begin in the root of the target directory hierarchy. This is an inconvenient implementation because it requires one case of circular references to be allowed. See the description of circular references below.
b) The preferred method is to take advantage of the fact that on the FAT file system used on Memory Stick the file name is not case-sensitive. If we define that the magic directory is case sensitive, then using \System\MSROOT will alter the path lookup to begin at the root of the target directory hierarchy, but any other case, such as \System\msroot, \System\MSRoot, \system\MSROOT will start from the default predefined position within the target and so give the true file/directory that exists on the Memory Stick.
   Circular References

Considering the conventional approach of a string substitution, it would be possible to make the translation repeatedly and create a circular reference. For example, the path:

\System\MSROOT\MSSymbian\System\MSROOT\MSSymbian\fred

is identical to

\fred

The problems to allowing this are:
1. It allows files to have aliases—that is, one file can be accessed by more than one name. This can provide serious problems to file sharing and locking semantics in upper layers which may see this as different files.
2. It can potentially lead to infinite loops—for example if a file browser application followed a circular reference forever.

However, this cannot occur in the present invention because only one path lookup takes place. After the file system has determined from the presence or absence of any “magic” prefix where to begin the search, it will do a single search within the target directory hierarchy for the rest of the request path. For example the path “\System\MSROOT\MSSymbian\System\MSROOT” appears to be a circular reference, but in fact the file system will only consider the first occurrence of the magic path, so that it will begin the search for the remaining path “MSSymbian\System\MSROOT” from the toot of the target directory hierarchy. This path either doesn't exist or will refer to an existing file or directory on the Memory Stick.

However this doesn't prevent applications from circularly referencing the Symbian root, \MSSymbian, via the \System\MSROOT magic directory. For example the files \fred.txt and \System\MSROOT\MSSymbian\fred.txt are identical but can cause the problems described above. Therefore if the application attempts to specifically access the MSSymbian the request will always be rejected. Access to that directory is only allowed by implication via the mechanism for starting path searches from within the target directory hierarchy. Thus in this example an attempt to access \System\MSROOT\MSSymbian\fred.txt would return an error indicating that access is denied, or equally effectively that the file could not be found.

Directory Listings

Generally directory listings proceed as normal with the translation resulting in the true directory on the Memory Stick, which is returned verbatim. All directory contents as seen by the application are identical to the directory contents on the Memory Stick except for the two special cases of \System\*, which contains the MSROOT magic directory and \System\MSROOT\* which is the root of the Memory Stick and contains the MSSymbian directory which is the root as seen by applications. These two cases need to be handled specially.

To avoid applications that search drives from accidentally straying into the magic \System\MSROOT directory and being able to accidentally create files in the root that do not comply with the Memory Stick standard, the magic directory does not appear in a listing of the \System directory content. An application that is Memory Stick-aware would know that it should use \System\MSROOT to access the root. Applications that are not aware of this will not find it in a directory listing so will not accidentally bypass the enforced SymbianOS directory structure.

Similarly, as described above circular access to the contents of MSSymbian via the magic directory must be prevented to avoid aliases. For consistency the best implementation would be to hide MSSymbian from a listing of the Memory Stick root and to return a “not found” error to any attempt by an application to use a path starting with

\System\MSROOT\MSSymbian.

(Note: the fact the an application must know of the presence of the MSROOT directory does not contradict the intention of the present method, since the application must also know how to deal with Memory Stick content and is therefore not a “standard” Symbian application which is unaware of Memory Sticks)

Emulating Standard Directories—Ghosting

One further extension is to provide non-existing “ghost” directories so that applications that are not specifically Memory Stick aware can still access files from the special Memory Stick directories. Take as an example a picture viewing application that normally stores its files in

\Documents\Pictures\ . . .

with a number of subdirectories below this which can be named by the user, for example “My Snaps”, “Holiday”, etc.

The file system can provide another “magic” directory but this time it maps one of the root directories into a directory within the Symbian hierarchy—a ghost of the root directory.

This is simply the “magic” directory mechanism as described above but with the start point for the path lookup changed from the root to some other directory within the target directory hierarchy.

So for the example picture viewer, we could create a new “magic” identifier for the ghost directory \Documents\Pictures\MemoryStick that actually starts path lookups from \DCIM in the Memory Stick root. The file system in this case is notionally substituting the ghost directory name with the real one.

Thus if the application performs a directory listing of its Pictures directory it will see
My Snaps
Holiday
MemoryStick
   and will then show “MemoryStick” as a possible place to find pictures to view. A directory listing of \Documents\Pictures\MemoryStick\* will effectively be converted to \DCIM\* by the file system and will return the content of the Memory Stick DCIM root directory. The picture viewer can then open any of the files and the same substitution will be done enabling the application to access files from a location it expects while they are actually somewhere else on the Memory Stick.
   Mapping without String Concatenation or Manipulation (Recap of the Invention)

In the present invention, we alter the point in the file system at which a directory lookup starts. This avoids the need for string substitution.

Consider how a lookup is performed. Take a media with this content:

\
\Documents

\accounts.doc
\info.doc

\Pictures

\Holiday

\landscape.jpg
\tree.jpg

An application then requests to open the file \Pictures\Holiday\landscape.jpg. This is essentially a recursive operation, where each component of the path is considered, traversing down the directory hierarchy. So step one is to search for an entry “Pictures” in the root directory. Once found, we move along one step and search for an entry “Holiday” in Pictures, and move along once more to find an entry “landscape.jpg” in Holiday.

Now consider that the hierarchy is on a Memory Stick like this:

\
\MSSymbian

\Documents

\accounts.doc
\info.doc

\Pictures

\Holiday

\landscape.jpg
\tree.jpg

In a conventional simple string manipulation, the application path \Pictures\Holiday\landscape.jpg is actually converted to:
\MSSymbian\Pictures\Holiday\landscape.jpg and the search proceeds as described starting with a search for “MSSymbian” in the root.

However the string manipulation and the initial search in the root are wasted effort and time. It is unnecessary to perform the search in the root as all entries are known to be inside the MSSymbian subdirectory. Therefore the better implementation would be to leave the application path unmodified but start the search from MSSymbian. So the search steps would start with a search for entry “Pictures” in MSSymbian and proceed to “landscape.jpg” in Holiday.

The magic directory redirecting to the root is handled by identifying the magic token in the path and skipping it, then starting the search from the root. For example, the application passes \System\MSROOT\DCIM, and the magic token “\System\MSROOT” is recognized and skipped. The search begins with finding an entry “DCIM” in the root.

1. A method of enabling an application, running on an operating system with a first directory hierarchy, to access files stored on a removable storage medium, in which the following steps occur:
(a) the application sends a file request with a path that conforms to the first directory hierarchy; and
(b) the file system starts a search for the file from a location within the second directory hierarchy that is different from the start location defined by the file request.

2. The method of claim 1 in which a prefix is attached to the original file request, and the file system interprets this prefix so as to change where the search begins on the second directory hierarchy.

3. The method of claim 1 in which the file system filters out parts of the second directory hierarchy during the search so as to present a view of the second directory hierarchy that conforms to the layout of the first directory hierarchy, or to hide parts of the second hierarchy to which access should be denied.

4. The method of claim 1 in which the storage medium is a storage medium that is removable from the device and conforms to the Memory Stick standard.

5. The method of claim 1 in which the step of identifying the location of the start of the search occurs automatically without the application having to be aware of this step or of the existence of the second directory hierarchy.

6. The method of claim 1 in which the location of the start of the search is not the root of the second directory hierarchy.

7. The method of claim 1 in which the step of identifying the location of the start of the search is performed by recognizing and skipping a predefined prefix of a file request path to ensure conformance to the second directory hierarchy.

8. The method of claim 7 in which recognizing and skipping the predefined prefix is only done once per path on the first occurrence of the predefined prefix.

9. The method of claim 1 in which the step of identifying the location of the start of the search is performed by mapping a non-existing directory that conforms to the directory hierarchy used by the operating system to a directory that conforms to the second directory hierarchy.

10. The method of claim 9 in which the mapping allows file interchange to occur.

11. The method of claim 10 in which the directory that conforms to the second directory hierarchy is a root directory.

12. A portable computing device programmed to enable an application running on it to access files stored on a storage medium, in which the application sends a file request with a path that conforms to a directory hierarchy used by the device operating system, the device being further programmed to search for the path in the file request starting from a location within a second directory hierarchy used by the storage medium, the second directory hierarchy being incompatible with the first.
